(19) United States
(12) Patent Application Publication
(10) Pub. No.: US 2026/0112824 A1
(43) Pub. Date: Apr. 23, 2026

(54) ELECTRICAL CONNECTION UNIT

(71) Applicant: YAZAKI CORPORATION, Tokyo (JP)

(72) Inventors: Ryu Senoo, Kakegawa-shi (JP); Hirotaka Mukasa, Kakegawa-shi (JP); Kazuhiko Tsuchiya, Kakegawa-shi (JP)

(21) Appl. No.: 19/342,742

(22) Filed: Sep. 29, 2025

(30) Foreign Application Priority Data
Oct. 1, 2024 (JP) 2024-172095

(51) Int. Cl. H01R 4/70; H01R 4/34; H02G 3/16

(52) U.S. Cl. CPC H01R 4/70; H01R 4/34; H02G 3/16

(57) ABSTRACT

An electrical connection unit includes a rigid member, an electronic component including a movable portion, a bus bar electrically connected to the electronic component, a base member including a first base portion that has a first surface facing the electronic component and a second surface located on a side opposite to the first surface and facing the rigid member and holds the bus bar, and a first fixing portion fixed to the rigid member, and a cushion member disposed between the rigid member and the base member or between the rigid member and the bus bar, and disposed between the electronic component and the first fixing portion when viewed from an intersecting direction intersecting the first surface.

### TECHNICAL FIELD

Embodiments of the present invention relate to an electrical connection unit.

Priority is claimed on Japanese Patent Application No. 2024-172095 filed in Japan on Oct. 1, 2024, the content of which is incorporated herein by reference.

### BACKGROUND ART

An electrical connection unit having a housing that accommodates electronic components and a bus bar attached to the housing in a standing posture is known.

### PRIOR ART DOCUMENT

### Patent Document

[Patent Document 1] Japanese Unexamined Patent Application, First Publication No. 2024-037492

### SUMMARY OF THE INVENTION

### Problems to be Solved by the Invention

Incidentally, in an electrical connection unit, it is expected to suppress emission of sound generated from a relay or the like including a movable portion and improve quietness.

An embodiment provides an electrical connection unit capable of improving quietness.

### Means for Solving the Problem

An electrical connection unit according to an embodiment includes a rigid member, an electronic component including a movable portion, a bus bar electrically connected to the electronic component, a base member including a first base portion that has a first surface facing the electronic component and a second surface located on a side opposite to the first surface and facing the rigid member and holds the bus bar, and a first fixing portion fixed to the rigid member, and a cushion member disposed between the rigid member and the base member or between the rigid member and the bus bar, and disposed between the electronic component and the first fixing portion when viewed from an intersecting direction intersecting the first surface.

### Effects of Invention

According to one embodiment, quietness can be improved.

### BRIEF DESCRIPTION OF THE DRAWINGS

FIG. 1 A cross-sectional view illustrating an electrical connection unit of an embodiment.

FIG. 2 A perspective view for describing a main body of the embodiment.

FIG. 3 A partially exploded perspective view of a connection unit of the embodiment.

FIG. 4 A partially exploded perspective view of a subunit of the embodiment.

FIG. 5 A perspective view for describing an electronic component and a connection component of the embodiment.

FIG. 6 A perspective view illustrating a routing board of the embodiment.

FIG. 7 A partially exploded perspective view of the routing board of the embodiment.

FIG. 8 A bottom view illustrating the routing board of the embodiment.

FIG. 9 A cross-sectional view taken along line IX-IX of the structure illustrated in FIG. 2.

### EMBODIMENTS FOR CARRYING OUT THE INVENTION

Hereinafter, embodiments will be described with reference to the drawings. In the following description, constitutions having the same or similar functions are denoted by the same reference numbers. Redundant descriptions of these constitutions may be omitted. Note that the constitution described below does not limit the scope of the embodiment.

In the present disclosure, the terms are defined as follows. The term “connection” is not limited to a mechanical connection, and may include an electrical connection. That is, the term “connection” is not limited to a case where two elements that are connection targets are directly connected and may include a case where two elements that are connection targets are electrically or mechanically connected with another element interposed therebetween. The term “accommodation” is not limited to a case where the entire component is accommodated and may include a case where only a part of the component is accommodated (a state in which the remaining part of the component protrudes). The term “facing” indicates that virtual projection images of two target objects overlap each other when viewed from a specific direction. That is, the term “facing” is not limited to a case where two target objects directly face each other, and may include a case where two target objects face each other in a state in which another member exists between the two target objects. “Orthogonal” may include a case of “substantially orthogonal”. “The same”may include a case of “substantially the same”.

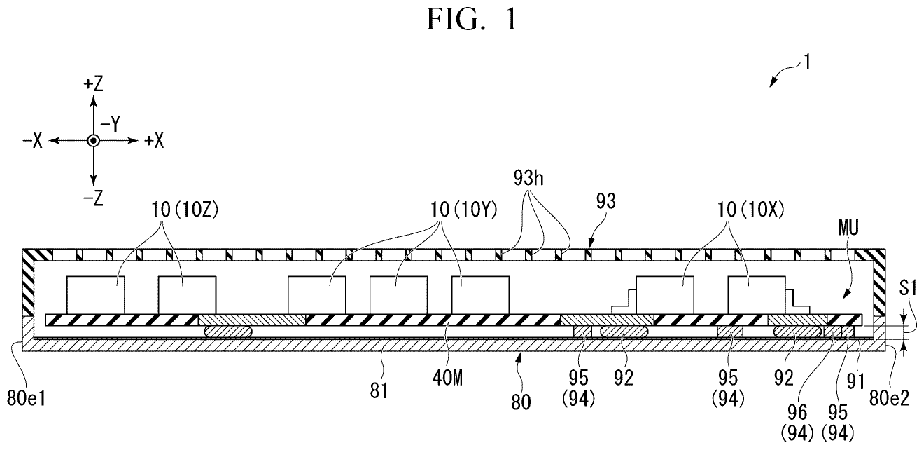

In the present disclosure, a +X direction, a −X direction, a +Y direction, a −Y direction, a +Z direction, and a −Z direction are defined as follows. As illustrated in FIGS. 1 to 3, the +X direction is a direction from a first end 80e1 to a second end 80e2 of the metal plate 80 that will be described later. The −X direction is a direction opposite to the +X direction. Hereinafter, in a case where the +X direction and the −X direction are not distinguished, the directions will be simply referred to as “X direction”. The +Y direction and the −Y direction are directions intersecting (for example, orthogonal to) the X direction. The +Y direction is a direction from a third end 80e3 to a fourth end 80e4 of the metal plate 80 that will be described later. The −Y direction is a direction opposite to the +Y direction. Hereinafter, in a case where the +Y direction and the −Y direction are not distinguished, the directions will be simply referred to as “Y direction”. The +Z direction and the −Z direction are directions intersecting (for example, orthogonal to) the X direction and the Y direction. The +Z direction is a direction from the metal plate 80 that will be described later toward a main body MU. The −Z direction is a direction opposite to the +Z direction. Hereinafter, in a case where the +Z direction and the −Z direction are not distinguished, the directions will be simply referred to as “Z direction”. The Z direction is an example of a “first direction” or an “intersecting direction”. The X direction is an example of a “second direction”. The “second direction” is not limited to the X direction, and may be the Y direction or other directions.

Hereinafter, in a case where the X direction and the Y direction are not distinguished, the directions may be referred to as “horizontal direction”. Hereinafter, the Z direction may be referred to as “vertical direction”. Hereinafter, the +Z direction side may be referred to as “upper”, and the −Z direction side may be referred to as “lower”. However, these expressions are expressions for convenience of description, and do not limit a gravity direction of an electrical connection unit 1 (an installation posture of the electrical connection unit 1).

### Embodiment

### 1. CONSTITUTION OF ELECTRICAL CONNECTION UNIT

The electrical connection unit 1 is, for example, an in-vehicle device mounted on a vehicle such as an electric vehicle (EV), a hybrid electric vehicle (HEV), or a plug-in hybrid electric vehicle (PHEV). The electrical connection unit 1 may be referred to as an “electrical connection box” or a “junction box”, for example. However, the electrical connection unit 1 is not limited to a box-shaped device.

The electrical connection unit 1 includes, for example, a main body MU, a metal plate 80, an insulating sheet 91, a plurality of heat transfer members 92, an insulating cover 93, and a plurality of cushion members 94.

### 2. MAIN BODY

First, the main body MU will be described.

The main body MU is a portion that performs a main function (for example, switching of electrical connection states or overcurrent protection) of the electrical connection unit 1. In the present embodiment, the main body MU is divided into a plurality of subunits SU. The main body MU is formed by connecting a plurality of subunits SU. In the present embodiment, the main body MU includes three subunits SU (subunits SUX, SUY, and SUZ). Each subunit SU may be referred to as a “circuit constitution body”.

The subunit SUX has an electrical first function. The subunit SUX includes, for example, a plurality of electronic components 10X and a routing board 40X. The plurality of electronic components 10X are electrically connected to the routing board 40X.

The subunit SUY has an electrical second function. The second function is a function different from the first function. The subunit SUY includes, for example, a plurality of electronic components 10Y and a routing board 40Y. The plurality of electronic components 10Y are electrically connected to the routing board 40Y.

The subunit SUZ has an electrical third function. The third function is a function different from the first function and the second function. The subunit SUZ includes, for example, a plurality of electronic components 10Z and a routing board 40Z. The plurality of electronic components 10Z are electrically connected to the routing board 40Z.

In the present embodiment, the three subunits SUX, SUY, and SUZ are disposed to be arranged in the X direction. For example, the subunit SUX is disposed on the +X direction side with respect to the subunit SUY. The subunit SUX and the subunit SUY are electrically connected. On the other hand, the subunit SUZ is disposed on the −X direction side with respect to the subunit SUY. The subunit SUZ and the subunit SUY are electrically connected.

In the present embodiment, the three routing boards 40X, 40Y, and 40Z included in the three subunits SUX, SUY, and SUZ are disposed on the same plane. In other words, the three routing boards 40X, 40Y, and 40Z are disposed at the same height position in the Z direction. With these constitutions, one large routing board 40M is formed by the three routing boards 40X, 40Y, and 40Z.

In the present embodiment, the three subunits SUX, SUY, and SUZ have the same or similar basic structure. One subunit SU will be described in detail below as a representative on the basis of this basic structure. Hereinafter, in a case where the subunit SUX, the subunit SUY, and the subunit SUZ are not distinguished, the subunits are simply referred to as “subunit SU”. In addition, in a case where the electronic component 10X, the electronic component 10Y, and the electronic component 10Z are not distinguished, the electronic components are simply referred to as “electronic component 10”. In a case where the routing board 40X, the routing board 40Y, and the routing board 40Z are not distinguished, the routing boards are simply referred to as “routing board 40”.

Note that the main body MU need not be divided into a plurality of subunits SU instead of the example described above. That is, the main body MU may be formed by the plurality of electronic components 10 and one routing board 40. In addition, the two or more subunits SU are not limited to the subunits SU having different functions, and may be the subunits SU having the same function.

### 3. CONSTITUTION OF SUBUNIT

Next, a constitution of the subunit SU will be described.

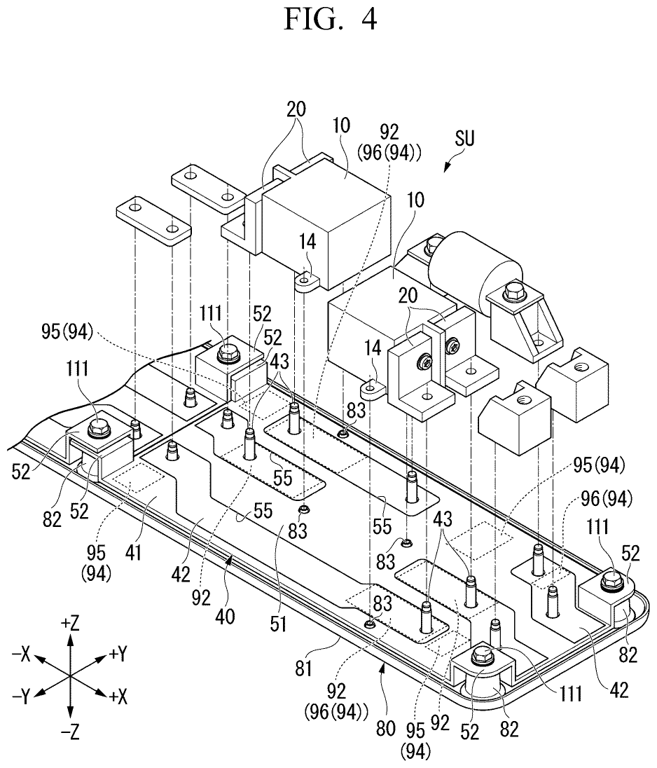

FIG. 4 is a partially exploded perspective view of the subunit SU. The subunit SU includes, for example, a plurality of electronic components 10, a plurality of connection components 20 for component connection, and a routing board 40. Each connection component 20 is a member forming an energization path in the vertical direction. Each connection component 20 may be referred to as a “vertical routing member”. The routing board 40 includes, for example, a base plate 41, one or more (for example, a plurality of) bus bars 42, and a plurality of fastening members 43.

### 3.1 Electronic Component and Connection Component for Component Connection

The plurality of electronic components 10 and the plurality of connection components 20 for component connection will be described.

The plurality of electronic components 10 are electronic components mounted in accordance with functions required for the subunit SU. The electronic component 10 is, for example, a relay (for example, a mechanical relay), and is a heat generating component that generates heat when energized. Each connection component 20 is a component that electrically connects the electronic component 10 to the routing board 40. The connection component 20 forms a part of an energization path in the subunit SU. The connection component 20 is made of a metal (for example, copper or a copper alloy). The connection component 20 may be referred to as a “metal component”. Another electronic component (for example, a connector, a fuse, a capacitor, a branch component, various sensors (for example, a current sensor or a voltage sensor), an electronic control unit, or an electronic component unit in which two or more of these are unitized) other than the electronic component 10 may be further mounted on the subunit SU. Note that the electronic component 10 and the corresponding connection component 20 will be described in detail below.

### 3.1.1 Electronic Component

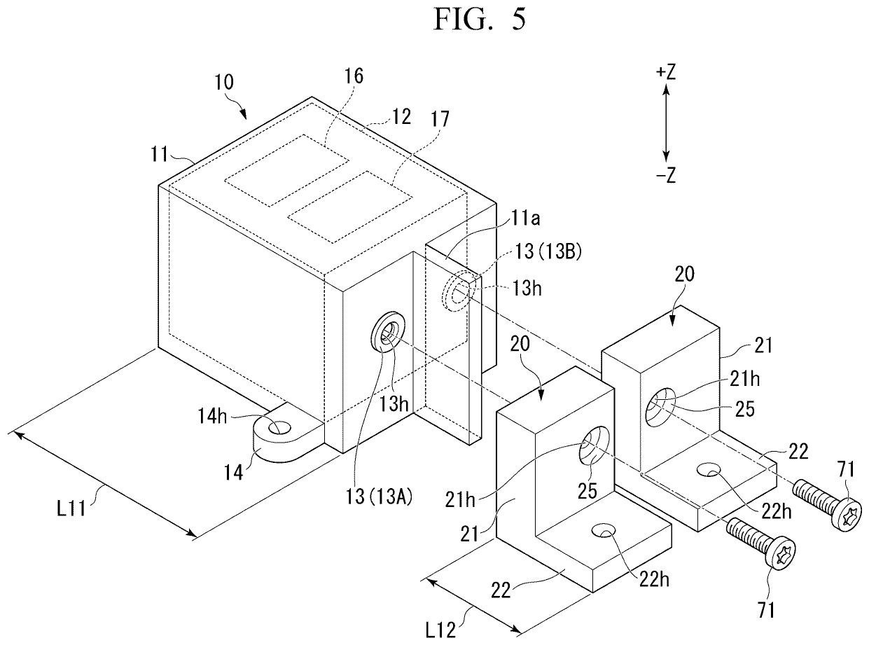

FIG. 5 is a perspective view illustrating the electronic component 10. The electronic component 10 is an electronic component that generates an operation sound. The electronic component 10 includes, for example, a case 11, a component body 12, a plurality of terminals 13, and a plurality of attachment portions 14. The plurality of terminals 13 are disposed to be arranged at one end of the electronic component 10, for example.

### Case

The case 11 is an outer member that forms most of the outer shape of the electronic component 10. The case 11 is made of, for example, synthetic resin and has an insulating property. The case 11 accommodates the component body 12. The case 11 and the component body 12 may be integrally formed.

In the present embodiment, the case 11 has an insulating rib 11a that protrudes in the horizontal direction (for example, the X direction) and extends in the Z direction. The insulating rib 11a has, for example, a plate shape formed in the horizontal direction (for example, the X direction) and the Z direction. The insulating rib 11a extends over the entire length of the case 11 in the Z direction, for example. The insulating rib 11a is disposed between the plurality of terminals 13 (a terminal 13A and a terminal 13B that will be described later). The insulating rib 11a electrically insulates the terminal 13A from the terminal 13B. In the present embodiment, a part of the insulating rib 11a is disposed between the first portions 21 (described later) of the two connection components 20 connected to the electronic component 10. The insulating rib 11a electrically insulates between the first portions 21 of the two connection components 20 connected to the electronic component 10.

### Component Body

The component body 12 is a portion that performs a main function of the electronic component 10. The component body 12 includes a braking portion 16 and a movable portion 17. The braking portion 16 includes, for example, a coil that generates a magnetic field by a coil current input to the electronic component 10. The movable portion 17 includes, for example, a movable contact that moves according to a magnetic field generated by the braking portion 16 and switches between a conduction state and a non-conduction state.

### Terminal

The terminal 13 is an electrical connection portion exposed to the outside of the case 11. The terminal 13 is electrically connected to the component body 12 inside the case 11. In the present embodiment, the electronic component 10 includes a terminal 13A and a terminal 13B as the plurality of terminals 13. One of the terminal 13A and the terminal 13B is a terminal on the positive electrode side. The other of the terminal 13A and the terminal 13B is a terminal on the negative electrode side. One of the terminal 13A and the terminal 13B is an example of a “first terminal”. The other of the terminal 13A and the terminal 13B is an example of a “second terminal”.

In the present embodiment, the terminal 13A and the terminal 13B are provided at one end of the electronic component 10 in the horizontal direction (for example, the X direction). The terminal 13A and the terminal 13B are disposed to be arranged in the horizontal direction (for example, the Y direction). Each terminal 13 has an attachment hole 13h to which a fastening member 71 (for example, a screw or a bolt) that will be described later is attached. The attachment hole 13h is open in the horizontal direction (for example, the X direction). An inner circumferential surface of the attachment hole 13h of the electronic component 10 has a screw groove.

### Attachment Portion

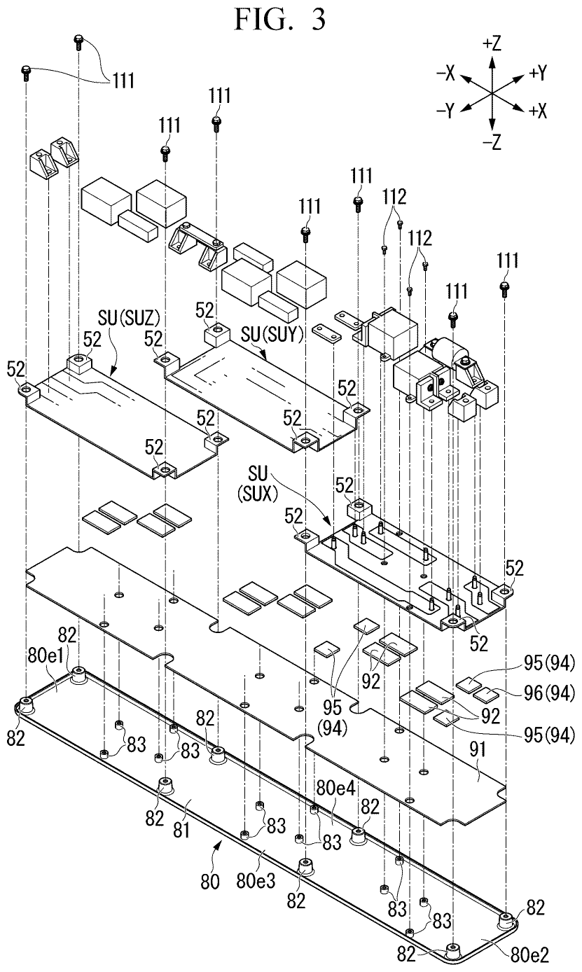

The attachment portion 14 is a portion for fixing the electronic component 10. The attachment portion 14 has an attachment hole 14h to which a fastening member 112 (for example, a screw or a bolt; and see FIG. 3) that will be described later is attached. The attachment hole 14h is open in the Z direction. The attachment hole 14h is an insertion hole through which the fastening member 112 passes. The attachment portion 14 is fixed to the metal plate 80.

### 3.1.2 Connection Component

The connection component 20 is a component that electrically connects the electronic component 10 to the routing board 40. In the present embodiment, the connection component 20 electrically connects the electronic component 10 to the bus bar 42 included in the routing board 40. In the present embodiment, a width L12 of the connection component 20 in the longitudinal direction (for example, the X direction) of the electronic component 10 is smaller than a width L11 of the electronic component 10 in the longitudinal direction. The connection component 20 includes, for example, a first portion 21 and a second portion 22.

### First Portion

The first portion 21 of the connection component 20 is a portion connected to the terminal 13 of the electronic component 10. The first portion 21 is a plate-shaped or rectangular parallelepiped portion extending in the Z direction. The first portion 21 extends in the Z direction along one end (for example, an end in the X direction) of the electronic component 10. The first portion 21 is a standing portion that stands in the Z direction with respect to the routing board 40 (for example, with respect to a bus bar 42 that will be described later). The first portion 21 is adjacent to the electronic component 10 in the horizontal direction (for example, the X direction). For example, the first portion 21 is adjacent to the terminal 13 of the electronic component 10 in the horizontal direction (for example, the X direction) and is connected to the terminal 13 of the electronic component 10 from the horizontal direction (for example, the X direction).

The first portion 21 of the connection component 20 has a first attachment hole 21h through which the fastening member 71 (for example, a screw or a bolt) passes. The first attachment hole 21h is open in the horizontal direction (for example, the X direction). The first portion 21 has a recess 25 around the first attachment hole 21h. The recess 25 is an accommodation portion that accommodates a head of the fastening member 71 inserted into the first attachment hole 21h. The fastening member 71 that has passed through the first attachment hole 21h is engaged with the attachment hole 13h of the terminal 13 of the electronic component 10, and thus the first portion 21 is physically and electrically connected to the terminal 13 of the electronic component 10. The first portion 21 need not have the recess 25.

### Second Portion

The second portion 22 of the connection component 20 is a portion connected to the bus bar 42. The second portion 22 protrudes in the horizontal direction (for example, the X direction) from end of the first portion 21 on the −Z direction side. The second portion 22 is a plate portion provided in the horizontal direction. The second portion 22 is adjacent to the bus bar 42 in the Z direction, and is connected to the bus bar 42 from the Z direction. The second portion 22 of the connection component 20 is attached to the fastening member 43(for example, a screw or bolt; and see FIG. 4) protruding from the bus bar 42 in the +Z direction from the Z direction and is physically and electrically connected to the bus bar 42. In the present embodiment, the second portion 22 of the connection component 20 has a second attachment hole 22h through which the fastening member 43 passes. The second attachment hole 22h is open in the Z direction. In the second portion 22, the fastening member 43 passes through the second attachment hole 22h. The engagement member 44 (for example, a nut) is engaged with the tip of the fastening member 43 that has passed through the second attachment hole 22h, and thus the second portion 22 is fixed to the bus bar 42. In the present embodiment, the first portion 21 and the second portion 22 form one L-shaped connection component 20.

### 3.2 Routing Board

Next, the routing board 40 will be described.

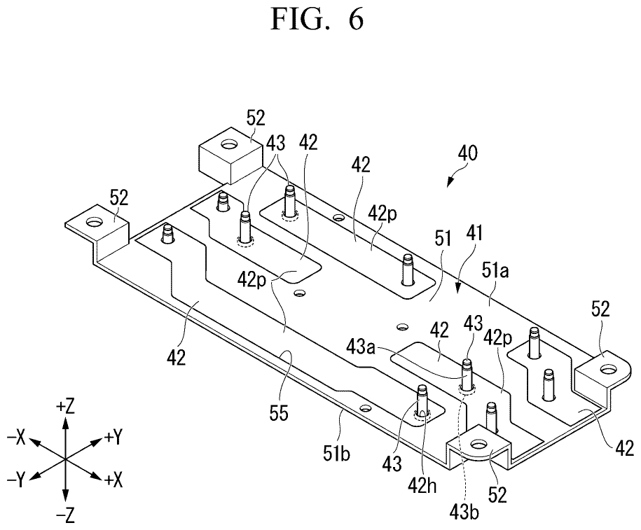

FIG. 6 is a perspective view illustrating the routing board 40. The routing board 40 is a member that forms at least a part of an energization path between the plurality of electronic components 10, and/or at least a part of an energization path between the electronic component 10 and another electronic component, and/or at least a part of an energization path between the electronic component 10 and an external device. In the present disclosure, the “routing board” indicates a board-type routing structure. The “board type” indicates a plate shape along one plane when viewed as a whole regardless of a fine shape. In the present disclosure, the term “plate shape”, “sheet shape”, or “planar” is not limited to the case of being completely flat, and may include a case where a fixing structure, a rib, or the like protruding in the Z direction is partially present, a case where an uneven shape following the thickness of the bus bar is present on the surface, and the like. In the present embodiment, the routing board 40 has a plate shape formed in the X direction and the Y direction.

In the present embodiment, the base plate 41 and the plurality of bus bars 42 are integrated through insert molding. For example, the routing board 40 is formed as a single member by insert-molding the bus bar 42 with the base plate 41 after the fastening member 43 is fixed to the bus bar 42. That is, the bus bar 42 is integrated with the base plate 41 without using a fastening member such as a screw or a bolt. Note that the routing board 40 may be formed by another structure instead of the insert molding. A modification example in which the routing board 40 is formed by another structure will be described later.

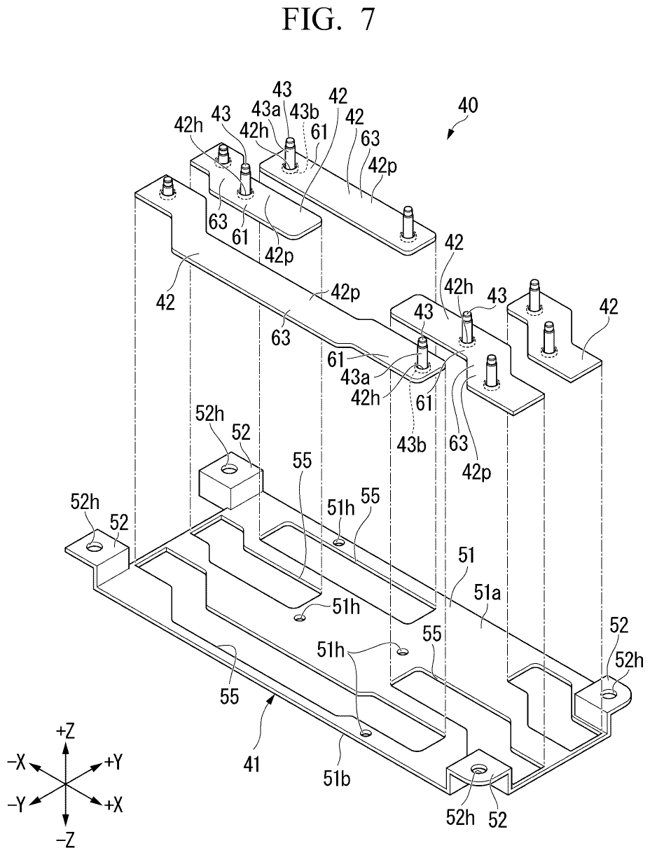

FIG. 7 is a partially exploded perspective view of the routing board 40. Hereinafter, for convenience of description, the base plate 41, the bus bar 42, and the fastening member 43 will be described with reference to the drawings in which the routing board 40 is partially exploded.

### Base Plate

The base plate 41 is a holding member that integrally holds the plurality of bus bars 42 arranged in the horizontal direction at intervals. The base plate 41 is made of, for example, synthetic resin and has an insulating property. The base plate 41 electrically insulates the plurality of bus bars 42 from each other. The base plate 41 is an example of a “base member”. The base plate 41 may be referred to as an “insulating substrate”. The base plate 41 includes, for example, a first flat surface portion 51 and a plurality of first fixing portions 52. The first flat surface portion 51 is an example of a first base portion. The first fixing portion 52 will be described later.

The first flat surface portion 51 is a portion formed in a plate shape in the base plate 41. The first flat surface portion 51 has a plate shape formed in the horizontal direction. The first flat surface portion 51 forms a main portion of the base plate 41. The first flat surface portion 51 forms a base portion (insulating base portion) of the base plate 41. In the present embodiment, the first flat surface portion 51 extends over the entire width of the base plate 41 in the X direction and over the entire width of the base plate 41 in the Y direction except for the four corner portions of the base plate 41.

The first flat surface portion 51 has a first surface 51a and a second surface 51b. The first surface 51a is a surface directed in the +Z direction. The first surface 51a is a flat surface provided in the horizontal direction. The first surface 51a faces the plurality of electronic components 10 and faces the insulating cover 93 (see FIG. 1) of the electrical connection unit 1. The second surface 51b is located on the side opposite to the first surface 51a. The second surface 51b is a surface directed in the −Z direction. The second surface 51b is a flat surface provided in the horizontal direction. The second surface 51b faces the metal plate 80 (see FIG. 1). The thickness direction (plate thickness direction) of the first flat surface portion 51 is the Z direction.

The first flat surface portion 51 has, for example, one or more (for example, a plurality of) accommodation portions 55 in which the bus bars 42 are accommodated, respectively. The plurality of accommodation portions 55 are formed apart from each other in the X direction or the Y direction. Each of the accommodation portions 55 is, for example, a through-hole penetrating the first flat surface portion 51 in the Z direction. Note that the accommodation portion 55 may be a recess provided in the first surface 51a or the second surface 51b of the first flat surface portion 51 and recessed in the Z direction, instead of the through-hole. In the present disclosure, the phrase “the accommodation portion penetrates the flat surface portion in the first direction (Z direction)” may include a case where a part of the entire length of the accommodation portion 55 penetrates the first flat surface portion 51 in the Z direction (for example, the remaining portion of the accommodation portion 55 may be a recess recessed in the Z direction, or may be provided inside the base plate 41 and not exposed to the outside of the base plate 41). Similarly, in the present disclosure, the phrase “the accommodation portion is recessed in the first direction (Z direction)” may include a case where a part of the entire length of the accommodation portion 55 is recessed in the Z direction (for example, a remaining portion of the accommodation portion 55 may be a through-hole penetrating the first flat surface portion 51 in the Z direction, or may be provided inside the base plate 41 and not exposed to the outside of the base plate 41).

Each accommodation portion 55 has an outer shape corresponding to the shape of the bus bar 42 to be accommodated when viewed from the Z direction. Each accommodation portion 55 accommodates a corresponding bus bar 42.

### Bus Bar

The bus bar 42 is a routing member (electrical connection member) included in the routing board 40. The bus bar 42 is, for example, a routing member for electrically connecting the plurality of electronic components 10 to each other or electrically connecting the electronic component 10 to another electronic component. Alternatively, the bus bar 42 may be a routing member for connecting the electronic component 10 to an external device. The bus bar 42 is made of a metal (for example, copper or a copper alloy) and has conductivity. In the present embodiment, the plurality of bus bars 42 are disposed to be arranged in the horizontal direction at intervals. The plurality of bus bars include portions disposed on the same plane. The plurality of bus bars 42 are held by the first flat surface portion 51 of the base plate 41.

At least a part of each bus bar 42 has a plate shape formed in the horizontal direction. At least a part of each bus bar 42 is accommodated in the accommodation portion 55 and extends along the first flat surface portion 51. That is, at least a part of each bus bar 42 extends along the first surface 51a of the first flat surface portion 51. At least a part of each bus bar 42 extends in the horizontal direction in the accommodation portion 55. In the present embodiment, each bus bar 42 has a plate shape formed in the horizontal direction over the entire bus bar 42. Each of the bus bars 42 is accommodated in the accommodation portion 55 over the entire length of the bus bar 42 and extends along the first flat surface portion 51. Hereinafter, a portion of each bus bar 42 accommodated in the accommodation portion 55 and extending along the first flat surface portion 51 may be referred to as a “plate portion 42p”. The bus bar 42 is a member that forms a horizontal energization path. The bus bar 42 may be referred to as a “horizontal routing member”.

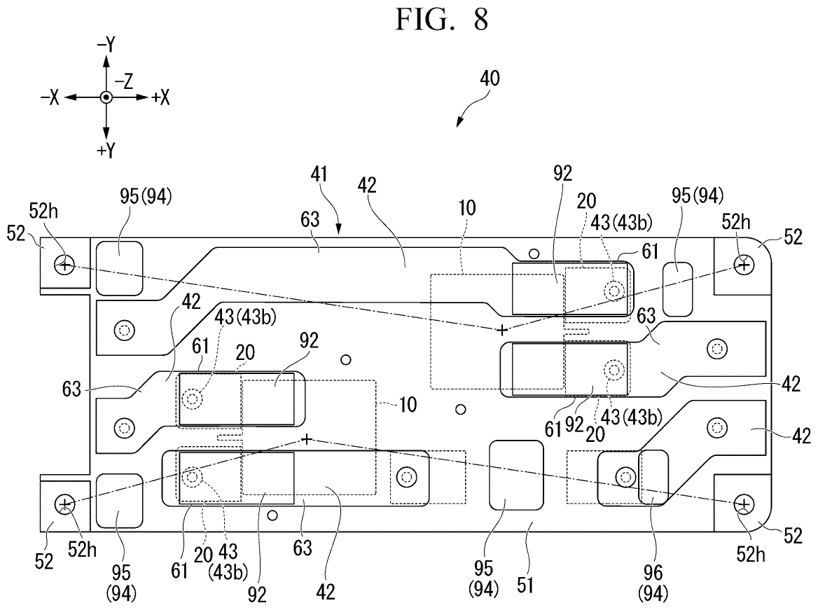

FIG. 8 is a plan view illustrating the routing board 40. The plate portion 42p of each bus bar 42 has, for example, a connection portion 61 and an extending portion 63.

The connection portion 61 is a portion in contact with one connection component 20. The connection component 20 is a connection component that connects one electronic component 10 to the bus bar 42. The connection portion 61 is a portion of the bus bar 42 overlapping the connection component 20 when viewed from the Z direction. The connection portion 61 is adjacent to the connection component 20 in the Z direction and is connected to the connection component 20 from the Z direction.

The extending portion 63 extends from the connection portion 61 in the X direction or the Y direction. The extending portion 63 may be provided, for example, between the connection portion 61 and another connection portion. For example, the extending portion 63 may extend over the connection portion 61 and another connection portion. The extending portion 63 may connect the connection portion 61 to another connection portion, for example.

In the present embodiment, the connection portion 61 and the extending portion 63 have a plate shape formed in the horizontal direction. In the present embodiment, each of the bus bars 42 is accommodated in the accommodation portion 55 and extends along the first flat surface portion 51. For example, the connection portion 61 and the extending portion 63 are accommodated in the accommodation portion 55 and extend along the first flat surface portion 51.

In the present embodiment, the extending portions 63 of some bus bars 42 are accommodated in the accommodation portions 55. That is, the bus bar 42 is accommodated in the accommodation portion 55 to be easily routed through a better path (for example, a path with a shorter distance) without being disturbed by the presence of the electronic component 10.

### Fastening Member

The fastening member 43 is a component for fixing the bus bar 42 and the connection component 20 which is a connection target component of the bus bar 42. The fastening member 43 is, for example, a caulking bolt fixed to the bus bar 42. The fastening member 43 is an example of a “fastening portion”.

As illustrated in FIG. 7, in the present embodiment, the connection portion 61 of each bus bar 42 has a through-hole 42h. The through-hole 42h penetrates the bus bar 42 in the Z direction. The fastening member 43 is, for example, a bolt having a shaft 43a and a head 43b. A circumferential surface of the shaft 43a has a screw groove. The diameter of the head 43b is larger than the diameter of the shaft 43a. The head 43b of the fastening member 43 is caulked and fixed to the bus bar 42 in a state in which the shaft 43a passes through the through-hole 42h of the bus bar 42. With this fixation, the fastening member 43 is electrically and physically connected to the bus bar 42 in a state in which the shaft 43a protrudes in the +Z direction from the through-hole 42h of the bus bar 42. The fastening member 43 is not limited to caulking fixation, and may be fixed to the bus bar 42 through welding or other methods.

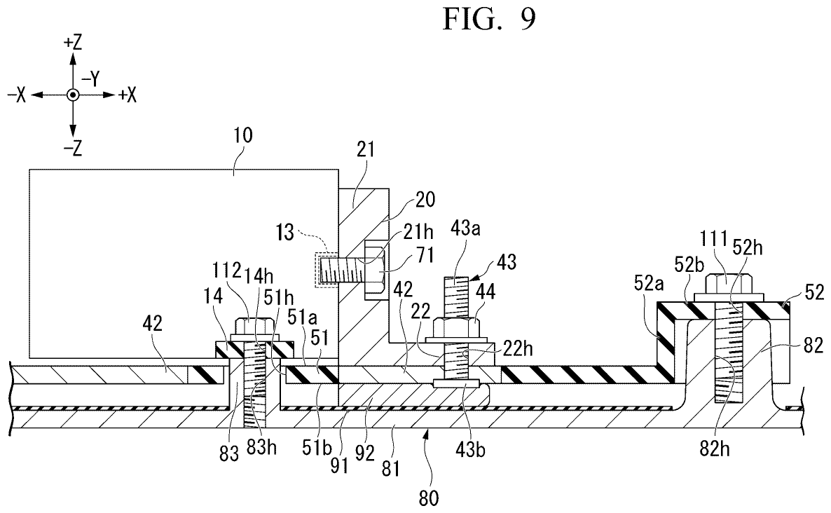

In the present embodiment, the connection component 20 is attached to the fastening member 43 from the Z direction in a state of being previously fixed to the electronic component 10 via the fastening member 71. For example, in the connection component 20, the shaft 43a of the fastening member 43 is inserted into the second attachment hole 22h of the second portion 22. Then, the engagement member 44 (for example, a nut; and see FIG. 9) is engaged with the shaft 43a of the fastening member 43 protruding from the second attachment hole 22h of the second portion 22 of the connection component 20. The engagement member 44 is attached to the shaft 43a in the Z direction, for example. This engagement fixes the second portion 22 of the connection component 20 to the fastening member 43.

### 4. METAL PLATE

Next, a constitution of the metal plate 80 will be described.

The metal plate 80 is a member for securing rigidity of the electrical connection unit 1 and enhancing a heat dissipation property of the electrical connection unit 1. The metal plate 80 is made of a metal (for example, aluminum or an aluminum alloy). The metal plate 80 may have a higher rigidity than the insulating sheet 91, for example. The metal plate 80 may be referred to as a “rigid member”.

As illustrated in FIGS. 1 to 3, the metal plate 80 has a long side extending in the X direction when viewed from the Z direction, and has a rectangular shape formed in the horizontal direction. The metal plate 80 has a first end 80e1, a second end 80e2, a third end 80e3, and a fourth end 80e4. The first end 80e1 and the second end 80e2 are a pair of ends of the metal plate 80 in the longitudinal direction, and are separated in the X direction. The third end 80e3 and the fourth end 80e4 are a pair of ends of the metal plate 80 in the lateral direction, and are separated in the Y direction. The metal plate 80 includes, for example, a second flat surface portion 81, a plurality of second fixing portions 82, and a plurality of third fixing portions 83. The second flat surface portion 81 is an example of a second base portion.

The second flat surface portion 81 is a portion formed in a plate shape in the metal plate 80. The second flat surface portion 81 has a plate shape formed in the horizontal direction. The second flat surface portion 81 forms a main portion of the metal plate 80. The second flat surface portion 81 forms a base portion (metal base portion) of the metal plate 80. In the present embodiment, the second flat surface portion 81 has a size that covers the three subunits SU from below. The second flat surface portion 81 faces the routing boards 40 of the three subunits SU. In the present embodiment, the metal plate 80 forms a gap S1 (see FIG. 1) including the insulating sheet 91 between the metal plate 80 and the second surface 51b of the first flat surface portion 51 of each subunit SU and faces the second surface 51b of the first flat surface portion 51 of each subunit SU.

The plurality of second fixing portions 82 are fixing portions for fixing the base plate 41 of each subunit SU to the metal plate 80. The plurality of second fixing portions 82 are provided at positions corresponding to the first fixing portions 52 of the base plate 41 of each subunit SU when viewed from the Z direction. Each of the second fixing portions 82 is a cylindrical or prismatic boss protruding in the +Z direction from the second flat surface portion 81 of the metal plate 80. Each of the second fixing portions 82 will be described in detail later.

The plurality of third fixing portions 83 are fixing portions for directly fixing the electronic component 10 of each subunit SU to the metal plate 80 without interposing the base plate 41. The plurality of third fixing portions 83 are provided at positions corresponding to the attachment portions 14 of the electronic components 10 of each subunit SU when viewed from the Z direction. Each of the third fixing portions 83 is a cylindrical or prismatic boss protruding in the +Z direction from the second flat surface portion 81. Each of the third fixing portions 83 will be described in detail later.

### 5. INSULATING SHEET

Next, a constitution of the insulating sheet 91 will be described.

The insulating sheet 91 is an insulating member for electrically insulating the metal plate 80 and the bus bar 42 of each subunit SU. The insulating sheet 91 is made of, for example, a synthetic resin such as polyester or polyimide, and has an insulating property. The insulating sheet 91 has a rectangular shape when viewed from the Z direction. The insulating sheet 91 has a sheet shape formed in the horizontal direction. The insulating sheet 91 is disposed between the second flat surface portion 81 of the metal plate 80 and the routing board 40 of each subunit SU. For example, the insulating sheet 91 may be disposed between the second flat surface portion 81 of the metal plate 80 and the plurality of heat transfer members 92. For example, the insulating sheet 91 may be disposed between the second flat surface portion 81 of the metal plate 80 and the plurality of cushion members 94.

In the present embodiment, the insulating sheet 91 is stuck on the second flat surface portion 81 of the metal plate 80. The insulating sheet 91 has a notch or an opening for avoiding the second fixing portion 82 and the third fixing portion 83 of the metal plate 80. Note that, instead of the above example, the insulating sheet 91 may be provided between the routing board 40 of each subunit SU and the plurality of heat transfer members 92. In a case where the plurality of heat transfer members 92 and the plurality of cushion members 94 have insulating properties, and necessary insulating properties are secured by the plurality of heat transfer members 92 and the plurality of cushion members 94, the insulating sheet 91 may be omitted.

### 6. HEAT TRANSFER MEMBER

Next, a constitution of the plurality of heat transfer members 92 will be described.

Each heat transfer member 92 is disposed between the metal plate 80 and the bus bar 42. Each heat transfer member 92 is sandwiched between the second flat surface portion 81 of the metal plate 80 and the bus bar 42. Each of the heat transfer members 92 transfers heat transferred from the electronic component 10 to the bus bar 42 and/or heat generated by the bus bar 42 from the bus bar 42 to the metal plate 80. Each of the heat transfer members 92 is a member for transferring heat generated by the electronic component 10 at the time of energization and/or heat (Joule heat) generated by the bus bar 42 itself at the time of energization to the metal plate 80. Each of the heat transfer members 92 is, for example, a heat transfer sheet (for example, a thermally conductive silicone sheet) having elasticity. Each of the heat transfer members 92 is made of a material having higher thermal conductivity than the base plate 41, for example. However, each heat transfer member 92 is not limited to the above example and may be a heat transfer member made of a thermally conductive gel or another material.

FIG. 8 is a bottom view illustrating the routing board 40 in which the plurality of heat transfer members 92 and the plurality of cushion members 94 are disposed. In the present embodiment, the plurality of heat transfer members 92 are partially provided in the routing board 40. For example, each heat transfer member 92 is disposed at a position overlapping a part of the corresponding bus bar 42 when viewed from the Z direction. More specifically, each heat transfer member 92 is disposed at a position overlapping a part of the corresponding bus bar 42 in the vicinity of the electronic component 10 when viewed from the Z direction. In the present embodiment, each heat transfer member 92 is disposed at a position overlapping the corresponding connection component 20 when viewed from the Z direction.

In the present embodiment, a part of each heat transfer member 92 is in contact with the corresponding bus bar 42 at a position overlapping the corresponding connection component 20 when viewed from the Z direction. In this case, each heat transfer member 92 easily transfers the heat transferred from the terminal 13 of the electronic component 10 to the connection component 20 from the corresponding connection component 20 to the metal plate 80 via the bus bar 42.

In the present embodiment, a part of each heat transfer member 92 is disposed at a position overlapping the head 43b of the corresponding fastening member 43 when viewed from the Z direction and is in contact with the head 43b of the corresponding fastening member 43. In this case, each heat transfer member 92 easily transfers the heat transferred from the terminal 13 of the electronic component 10 to the connection component 20 from the corresponding fastening member 43 to the metal plate 80.

In the present embodiment, a part of each heat transfer member 92 is in contact with the corresponding bus bar 42 at a position overlapping the corresponding electronic component 10 when viewed from the Z direction. In this case, each heat transfer member 92 easily transfers the heat transferred from the corresponding electronic component 10 to the bus bar 42 from the bus bar 42 to the metal plate 80. When the upper surface of each bus bar 42 is in contact with the corresponding electronic component 10, each bus bar 42 is thermally connected to the corresponding electronic component 10.

### 7. CUSHION MEMBER

Next, a constitution of the plurality of cushion members 94 will be described.

Each cushion member 94 is disposed between the metal plate 80 and the corresponding routing board 40. The cushion member 94 is sandwiched between the metal plate 80 and the corresponding routing board 40 and is elastically deformed and held. The cushion member 94 may be disposed, for example, between the metal plate 80 and the corresponding base plate 41, or between the metal plate 80 and the bus bar 42.

Each cushion member 94 is disposed between the corresponding electronic component 10 and the corresponding first fixing portion 52 when viewed from the Z direction. Each cushion member 94 may be disposed on, for example, a line segment connecting the center position of the corresponding electronic component 10 and the center position of the corresponding first fixing portion 52 when viewed from the Z direction. Each cushion member 94 may be disposed on, for example, a line segment connecting the center position of the movable portion 17 of the corresponding electronic component 10 and the center position of the corresponding first fixing portion 52 when viewed from the Z direction. Each cushion member 94 may be disposed on, for example, a line segment connecting the center position of a portion that generates sound in the corresponding electronic component 10 and the center position of the corresponding first fixing portion 52 when viewed from the Z direction. For example, each cushion member 94 may be separated from the electronic component 10 when viewed from the Z direction. For example, each cushion member 94 may be separated from the first fixing portion 52 when viewed from the Z direction. For example, each cushion member 94 may be disposed closer to the corresponding first fixing portion 52 than the corresponding electronic component 10 when viewed from the Z direction.

The electrical connection unit 1 includes a first cushion element 95 as the cushion member 94. In addition, the electrical connection unit 1 includes a second cushion element 96 as the cushion member 94. Among the plurality of cushion members 94, each of some of the cushion members 94 may be, for example, the first cushion element 95. Among the plurality of cushion members 94, at least one cushion member 94 (other than the first cushion element 95) may be, for example, the second cushion element 96. Although only one second cushion element 96 is illustrated in FIG. 8, the electrical connection unit 1 may include a plurality of second cushion elements 96.

Each first cushion element 95 is separated from the corresponding bus bar 42. Each of the first cushion elements 95 is sandwiched between the first flat surface portion 51 of the corresponding base plate 41 and the second flat surface portion 81 of the metal plate 80 and is elastically deformed and held. Each of the first cushion elements 95 is in contact with the second flat surface portion 81 of the metal plate 80 on the −Z direction side. Each of the first cushion elements 95 is in contact with the first flat surface portion 51 of the corresponding base plate 41 on the +Z direction side. Each first cushion element 95 is provided separately from the plurality of heat transfer members 92. Each first cushion element 95 may be separated from the plurality of heat transfer members 92.

Each the first cushion element 95 may be made of a material having thermal conductivity but need not be made of a material having thermal conductivity. Each first cushion element 95 may be, for example, rubber having an electrical insulating property.

The second cushion element 96 is sandwiched between the second flat surface portion 81 of the metal plate 80 and the corresponding bus bar 42 and is elastically deformed and held. The second cushion element 96 is in contact with the second flat surface portion 81 of the metal plate 80 on the −Z direction side. Each of the second cushion elements 96 is in contact with the corresponding bus bar 42 on the +Z direction side.

The second cushion element 96 is, for example, a heat transfer sheet (for example, a thermally conductive silicone sheet) having elasticity. Each of the second cushion elements 96 is made of a material having higher thermal conductivity than the base plate 41, for example. However, the second cushion element 96 is not limited to the above example, and may be a heat transfer member made of a thermally conductive gel or another material. Each of the second cushion elements 96 is disposed at a position overlapping a part of the corresponding bus bar 42 when viewed from the Z direction. The second cushion element 96 may also be used as, for example, a heat transfer member.

### 8. INSULATING COVER

Referring to FIG. 1 again, a constitution of the insulating cover 93 will be described.

The insulating cover 93 is a member for preventing the main body MU from contacting the energization path. The insulating cover 93 is made of, for example, a synthetic resin and has an insulating property. The insulating cover 93 has, for example, a box shape that is open on the −Z direction side. The insulating cover 93 has a plurality of vent holes 93h. The insulating cover 93 is attached to the metal plate 80 in the Z direction. Note that the insulating cover 93 is not limited to a box-shaped member, and may be a sheet-shaped member that covers the energization path of the main body MU.

### 9. EXPOSURE STRUCTURE OF BUS BAR

Next, an exposure structure of each bus bar 42 will be described.

First, an exposure structure on the upper surface side of each bus bar 42 will be described with reference to FIGS. 6 and 7. In the present embodiment, at least a part of the extending portion 63 of the bus bar 42 is exposed to the outside of the base plate 41 on the upper surface side (the first surface 51a side of the first flat surface portion 51). For example, the extending portion 63 of the bus bar 42 is exposed to the outside of the base plate 41 on the upper surface side at least in a part of a region overlapping the corresponding electronic component 10 when viewed from the Z direction.

In the present embodiment, the bus bar 42 is accommodated in the accommodation portion 55 over the entire length of the bus bar 42 and extends along the first surface 51a of the first flat surface portion 51. The bus bar 42 is exposed to the outside of the base plate 41 on the upper surface side over the entire length of the bus bar 42.

As illustrated in FIG. 8, at least a part of extending portion 63 of bus bar 42 is exposed to the outside of base plate 41 not only on the upper surface side but also on the lower surface side (second surface 51b side). For example, the bus bar 42 is exposed to the outside of the base plate 41 on the lower surface side over the entire length of the bus bar 42.

### 10. FIXING STRUCTURE

Next, a fixing structure of the subunit SU will be described.

### 10.1 Structure of Metal Plate

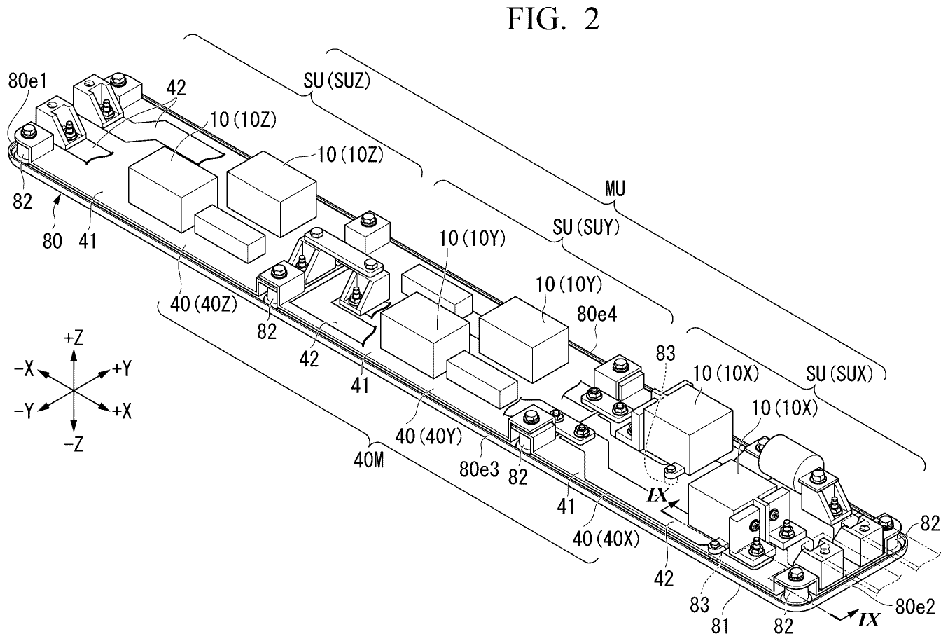

FIG. 9 is a cross-sectional view taken along line IX-IX of the structure illustrated in FIG. 2. As described above, the metal plate 80 includes the second fixing portion 82 and the third fixing portion 83.

The second fixing portion 82 is a boss protruding in the +Z direction from the second flat surface portion 81 of the metal plate 80. For example, the second fixing portion 82 protrudes to the +Z direction side than the first surface 51a of the first flat surface portion 51 of the base plate 41. In the present embodiment, the second fixing portion 82 protrudes more in the +Z direction than the third fixing portion 83 that will be described later. The second fixing portion 82 faces the first fixing portion 52 of the base plate 41 in the Z direction. The second fixing portion 82 has an engagement hole 82h that is open in the +Z direction. An inner circumferential surface of the engagement hole 82h has a screw groove.

The third fixing portion 83 is a boss protruding in the +Z direction from the second flat surface portion 81. The third fixing portion 83 is inserted into a through-hole 51h (described later) of the first flat surface portion 51 of the base plate 41. For example, the third fixing portion 83 passes through the through-hole 51h of the first flat surface portion 51 and protrudes to the same position as the first surface 51a of the first flat surface portion 51 or protrudes beyond a position of the first surface 51a of the first flat surface portion 51 (a position on the +Z direction side with respect to the first surface 51a). The third fixing portion 83 faces the attachment portion 14 of the electronic component 10 in the Z direction. The third fixing portion 83 has an engagement hole 83h that is open in the +Z direction.

A fastening member 112 (for example, a screw or a bolt) passes through the attachment hole 14h of the attachment portion 14 of the electronic component 10 from the +Z direction side. When the fastening member 112 that has passed through the attachment hole 14h of the attachment portion 14 of the electronic component 10 is engaged with the engagement hole 83h of the third fixing portion 83 of the metal plate 80, the electronic component 10 is fixed to the metal plate 80 without passing through the base plate 41. The fastening member 112 is an example of a “second fastening member”.

### 10.2 Structure of Routing Board

The base plate 41 includes a first fixing portion 52 fixed to the second fixing portion 82 of the metal plate 80. The first fixing portion 52 includes, for example, a standing plate portion 52a and a horizontal plate portion 52b.

The standing plate portion 52a stands in the +Z direction from the end of the first flat surface portion 51 of the base plate 41. The standing plate portion 52a is a plate portion provided in the Y direction and the Z direction. The thickness direction of the standing plate portion 52a is the X direction.

The horizontal plate portion 52b extends in the horizontal direction from the end of the standing plate portion 52a in the +Z direction. The horizontal plate portion 52b is a plate portion provided in the horizontal direction. The horizontal plate portion 52b faces the second fixing portion 82 of the metal plate 80 in the Z direction. The horizontal plate portion 52b has an insertion hole 52h facing the engagement hole 82h of the second fixing portion 82 of the metal plate 80. A fastening member 111 (for example, a screw or a bolt) passes through the insertion hole 52h. When the fastening member 111 that has passed through the insertion hole 52h of the first fixing portion 52 of the base plate 41 is engaged with the engagement hole 82h of the second fixing portion 82 of the metal plate 80, the base plate 41 is fixed to the metal plate 80. The fastening member 111 is an example of a “first fastening member”. The standing plate portion 52a is an example of a “first portion”. The horizontal plate portion 52b of the subunit SUX is an example of a “second portion”.

The first flat surface portion 51 of the base plate 41 has the above-described through-hole 51h. The through-hole 51h penetrates the first flat surface portion 51 in the Z direction. The through-hole 51h is provided at a position corresponding to the third fixing portion 83 of the metal plate 80 when viewed from the Z direction. The third fixing portion 83 of the metal plate 80 passes through the through-hole 51h of the base plate 41 and protrudes to the same position as the first surface 51a of the first flat surface portion 51 or protrudes further toward the +Z direction side than the first surface 51a of the first flat surface portion 51. The attachment portion 14 of the electronic component 10 is fixed to the third fixing portion 83 at the same position as the first surface 51a of the first flat surface portion 51 or at a position located further toward the +Z direction side than the first surface 51a of the first flat surface portion 51.

### 11. FIXING STRUCTURE RELATED TO PLURALITY OF SUBUNITS

Next, referring back to FIGS. 1 to 3, a fixing structure related to the plurality of subunits SU will be described. In the present embodiment, the main body MU is divided into a plurality of subunits SU (for example, three subunits SUX, SUY, and SUZ).

The subunit SUX includes the plurality of electronic components 10X, the base plate 41, and the plurality of bus bars 42. The plurality of bus bars 42 include portions disposed on the same plane, and are electrically connected to the plurality of electronic components 10X. The subunit SUX is an example of a “first subunit”.

The subunit SUY includes the plurality of electronic components 10Y, the base plate 41, and the plurality of bus bars 42. The plurality of bus bars 42 include portions disposed on the same plane, and are electrically connected to the plurality of electronic components 10Y. The subunit SUY is electrically connected to the subunit SUX via a coupling bus bar or the like. The subunit SUY is an example of a “second subunit”.

The subunit SUZ includes the plurality of electronic components 10Z, the base plate 41, and the plurality of bus bars 42. The plurality of bus bars 42 include portions disposed on the same plane, and are electrically connected to the plurality of electronic components 10Z. The subunit SUZ is electrically connected to the subunit SUY via a coupling bus bar or the like. The subunit SUZ is an example of a “third subunit”.

In the present embodiment, each of the plurality of subunits SU (for example, three subunits SUX, SUY, and SUZ) is fixed to the metal plate 80. With this constitution, the plurality of subunits SU (for example, three subunits SUX, SUY, and SUZ) are integrally held by one metal plate 80.

In the present embodiment, the longitudinal direction of the subunit SUX is the X direction. The longitudinal direction of the subunit SUY is the X direction. The longitudinal direction of the subunit SUZ is the X direction. The plurality of subunits SU (for example, three subunits SUX, SUY, and SUZ) are adjacent to each other in the X direction and are arranged in a line in the X direction. The longitudinal direction of the metal plate 80 is the X direction. The length of the metal plate 80 in the X direction is larger than the sum of the lengths of the plurality of subunits SU (for example, three subunits SUX, SUY, and SUZ) in the X direction.

In the present embodiment, the first fixing portion 52 of the subunit SUX and the first fixing portion 52 of the subunit SUY are disposed at positions where the first fixing portions 52 overlap each other in the Z direction. The first fixing portion 52 of the subunit SUX and the first fixing portion 52 of the subunit SUY are collectively fixed to the second fixing portion 82 of the metal plate 80 via one fastening member 111.

Similarly, the first fixing portion 52 of the subunit SUY and the first fixing portion 52 of the subunit SUZ are disposed at positions where the first fixing portions 52 overlap each other in the Z direction. The first fixing portion 52 of the subunit SUY and the first fixing portion 52 of the subunit SUZ are collectively fixed to the second fixing portion 82 of the metal plate 80 via one fastening member 111.

In the present embodiment, heat generated by the electronic component 10X and the bus bar 42 included in the subunit SUX is transferred to the metal plate 80 via the one or more heat transfer members 92 facing the subunit SUX. Similarly, heat generated by the electronic component 10Y and the bus bar 42 included in the subunit SUY is transferred to the metal plate 80 via the one or more heat transfer members 92 facing the subunit SUY. Heat generated by the electronic components 10Z and the bus bars 42 included in the subunit SUZ is transferred to the metal plate 80 via the one or more heat transfer members 92 facing the subunit SUZ.

In the present embodiment, the plurality of subunits SU (for example, three subunits SUX, SUY, and SUZ) may have different amount of heat generation. Even in a case where the amount of heat generation of the plurality of subunits SU are different, it is possible to promote cooling of the plurality of subunits SU (for example, three subunits SUX, SUY, and SUZ) by using one large metal plate 80. For example, in a case where the amount of heat generation of the plurality of subunits SU are different, the heat of the plurality of subunits SU can be equalized by one large metal plate 80.

### 12. ADVANTAGES

### A. Advantages Related to Cushion Member

According to the present embodiment, each cushion member 94 is disposed between the electronic component 10 including the movable portion 17 and the first fixing portion 52 when viewed from the Z direction. With this constitution, among types of sound generated from the electronic component 10, sound transmitted to the metal plate 80 via the first fixing portion 52 is absorbed by the respective cushion members 94. Through this operation, the sound generated from the electronic component 10 is less likely to be transmitted to the metal plate 80, and the emission of the sound generated from the electronic component 10 can be suppressed. Therefore, the quietness can be improved.

According to the present embodiment, the second fixing portion 82 protruding from the second flat surface portion 81 is fixed to the first fixing portion 52. With this constitution, of the sound generated from the electronic component 10, the sound transmitted to the metal plate 80 via the first fixing portion 52 is absorbed by each cushion member 94 and then transmitted to the second flat surface portion 81 via the second fixing portion 82 protruding from the second flat surface portion 81. Through this operation, the sound generated from the electronic component 10 is less likely to be transmitted to the second flat surface portion 81, and the emission of the sound generated from the electronic component 10 can be suppressed. Therefore, the quietness can be improved.

According to the present embodiment, the first cushion element 95 is separated from the bus bar 42 with respect to the heat transfer member 92 overlapping the bus bar 42 when viewed from the Z direction. With this constitution, a space that hardly hinders heat dissipation of the bus bar 42 can be used as a disposition space of the first cushion element 95. If such a space can be used, the first cushion element 95 can be easily disposed. Therefore, it is easy to suppress emission of sound generated from the electronic component 10. In addition, with this constitution, a material of the first cushion element 95 is not limited to a material having high thermal conductivity such as the material forming the heat transfer member 92, but a material having low thermal conductivity may be used. For example, the material of the first cushion element 95 is not limited to a material having high thermal conductivity, and a material that easily absorbs sound generated from the electronic component 10 can be applied. Therefore, it is easy to suppress emission of sound generated from the electronic component 10.

According to the present embodiment, the second cushion element 96 overlaps the bus bar 42 when viewed from the Z direction. With this constitution, the second cushion element 96 can suppress emission of sound generated from the electronic component 10 and transfer heat from the bus bar 42 to the metal plate 80. For example, if the second cushion element 96 can transfer heat, the second cushion element 96 and the heat transfer member can be used in common. Therefore, the number of components can be reduced.

According to the present embodiment, the electrical connection unit 1 includes the metal plate 80 as a rigid member that faces and is fixed to the routing board 40 and sandwiches the plurality of heat transfer members 92 and the plurality of cushion members 94. With this constitution, heat generated in the electronic component 10, the bus bar 42, and the like can be dissipated to the metal plate 80. Therefore, it is possible to suppress emission of sound generated from the electronic component 10 while promoting heat dissipation of the electrical connection unit 1.

### B. Advantages Related to Routing Board

According to the present embodiment, it is easy to reduce the height of the electrical connection unit 1. As a comparative example, an electrical connection unit in which a bus bar is disposed in a standing posture with respect to a lower wall of a housing will be considered. In such a constitution of the comparative example, for example, since a cross-sectional area of a bus bar is determined in order to function as a routing member, it may be difficult to reduce a width (height) of the standing bus bar. In this case, the width of the standing bus bar becomes a bottleneck, and it may be difficult to reduce a height of the electrical connection unit.

In contrast to such a comparative example, in the present embodiment, the electrical connection unit 1 includes the electronic component 10 and the routing board 40. The routing board 40 includes the base plate 41 and the bus bar 42. The base plate 41 has the plate-shaped first flat surface portion 51 having the first surface 51a facing the electronic component 10. The first flat surface portion 51 has the accommodation portion 55 recessed in the Z direction or penetrating the first flat surface portion 51 in the Z direction. At least a part of the bus bar 42 is accommodated in the accommodation portion 55 and extends along the first flat surface portion 51. According to such a constitution, compared with the structure of the comparative example in which at least a part of the routing path is formed on a plane, the width of the bus bar is less likely to be a bottleneck, and the height of the electrical connection unit 1 can be easily reduced.

In particular, in the present embodiment, in the electrical connection unit 1 for reducing the height, for example, the cushion member 94 can suppress the sound transmitted to the metal plate 80 while the electronic component 10 and the metal plate 80 are close to each other. Therefore, it is possible to achieve both the height reduction and the quietness.

In the present embodiment, the electrical connection unit 1 has the connection component 20. The connection component 20 electrically connects the electronic component 10 to the bus bar 42. The bus bar 42 has the connection portion 61 in contact with the connection component 20. The connection portion 61 is accommodated in the accommodation portion 55 and extends along the first flat surface portion 51. According to such a constitution, since more portions of the routing path are formed on a plane, it is further easy to reduce the height of the electrical connection unit 1.

In the present embodiment, the bus bar 42 is accommodated in the accommodation portion 55 over the entire length of the bus bar 42 and extends along the first flat surface portion 51. According to such a constitution, since more portions of the routing path are formed on a plane, it is further easy to reduce the height of the electrical connection unit 1.

### C. Advantages Related to Flat Bus Bar

According to the present embodiment, it is possible to improve the assemblability of the electrical connection unit 1. As a comparative example, an electrical connection unit in which a bus bar is disposed in a standing posture with respect to a lower wall of a housing will be considered. In such a constitution of the comparative example, it is necessary to fix the bus bar to the housing in a standing posture, and it is difficult to improve workability regarding attachment of the bus bar. In this case, it may be difficult to improve the assemblability of the electrical connection unit 1.

In contrast to such a comparative example, in the present embodiment, the electrical connection unit 1 includes the base plate 41 and the bus bar 42. The base plate 41 includes the plate-shaped first flat surface portion 51. The first flat surface portion 51 has the accommodation portion 55 recessed in the Z direction or penetrating the first flat surface portion 51 in the Z direction. At least a part of the bus bar 42 is accommodated in the accommodation portion 55 and extends along the first flat surface portion 51. According to such a constitution, the base plate 41 and the bus bar 42 can be easily handled integrally, and workability regarding attachment of the bus bar can be improved compared with the constitution of the comparative example. Therefore, the assemblability of the electrical connection unit 1 can be improved.

In particular, in the present embodiment, in the electrical connection unit 1 for improving assemblability, for example, the cushion member 94 can suppress sound transmitted to the metal plate 80 while the electronic component 10 and the metal plate 80 are close to each other. Therefore, it is possible to achieve both improvement in assemblability and quietness.

In the present embodiment, the bus bar 42 is accommodated in the accommodation portion 55 over the entire length of the bus bar 42 and extends along the first flat surface portion 51. According to such a constitution, it is easy to reduce the height of the electrical connection unit 1 while improving the assemblability of the electrical connection unit 1.

In the present embodiment, the bus bar 42 is integrated with the base plate 41 through insert molding. According to such a constitution, it is possible to eliminate or reduce the work of manually attaching the bus bar 42 to the housing. Therefore, the assemblability of the electrical connection unit 1 can be further improved.

In the present embodiment, the fastening member 43 protruding from the bus bar 42 in the Z direction and the connection component 20 attached to the fastening member 43 from the Z direction are provided. The connection component 20 electrically connects the electronic component 10 to the bus bar 42. According to such a constitution, a direction of work of attaching a connection target component to the bus bar 42 can be easily aligned with the Z direction. In a case where the direction of work can be aligned, the assemblability of the electrical connection unit 1 can be further improved.

In the present embodiment, the connection component 20 is connected to the electronic component 10 from the X direction (or the Y direction). According to such a constitution, a connection direction of the electronic component 10 with respect to the bus bar 42 can be converted into the Z direction by using the connection component 20 for the electronic component 10 that needs to be connected from the X direction. Therefore, the assemblability of the electrical connection unit 1 can be further improved.

### 13. MODIFICATION EXAMPLES

Next, several modification examples will be described. Note that constitutions other than those described below in each modification example are the same as the constitutions of the above-described embodiment.

### First Modification Example

Each of the bus bars 42 is not limited to a structure in which at least a part of the base plate 41 is exposed to the outside on the upper surface side and the lower surface side. As a modification example, the entire bus bar 42 may be covered with the base plate 41 on the upper surface side. As another modification example, the entire bus bar 42 may be covered with the base plate 41 on the lower surface side. At that time, on the +Z direction side of each of the second cushion elements 96, the second cushion element 96 need not be in contact with the bus bar 42 as long as it is in contact with the base plate 41 covering the bus bar 42. On the +Z direction side of each of the heat transfer members 92, the heat transfer member 92 need not be in contact with the bus bar 42 as long as it is in contact with the base plate 41 covering the bus bar 42.

### Second Modification Example

The base member including the first base portion is not limited to the base plate 41 including the first flat surface portion 51. As a modification example, the base member may be a member including a first base portion such as a block portion, a curved portion, or a bent portion instead of the first flat surface portion 51.

### Third Modification Example

The rigid member is not limited to the metal plate 80. As a modification example, the rigid member may be a metal block. As another modification example, the rigid member may be a resin plate. As still another modification example, the rigid member may be a resin block.

### Fourth Modification Example

The rigid member including the second base portion is not limited to the metal plate 80 including the second flat surface portion 81. As a modification example, the rigid member may be a member including a second base portion such as a block portion, a curved portion, and a bent portion instead of the second flat surface portion 81.

### Fifth Modification Example

The routing board 40 is not limited to a structure in which the base plate 41 and the bus bar 42 are integrated through insert molding. For example, the bus bar 42 may be disposed in the accommodation portion 55 after the base plate 41 provided with the accommodation portion 55 for accommodating the bus bar 42 is molded. In this case, the bus bar 42 may be fixed to the accommodation portion 55 through fitting or may be fixed to the accommodation portion 55 via an adhesive or other fixing means. In these cases, potting may be performed to fill a gap between the bus bar 42 and the accommodation portion 55.

### Sixth Modification Example

The base member of the routing board 40 is not limited to the base plate 41 including the plate-shaped first flat surface portion 51. The routing board 40 may be a base member (for example, an insulating sheet) having the sheet-shaped first flat surface portion 51. In this case, the accommodation portion 55 may be formed by a part of the first flat surface portion 51 following the outer shape of the bus bar 42. In the present disclosure, the “sheet-shaped” or “sheet” is not limited to a member having a thickness of 1 mm or more, and a member (so-called a film) having a thickness of less than 1 mm can also be used.

### Seventh Modification Example

The base plate 41 of the routing board 40 may include a plurality of members (plate members or sheet members). The plurality of members are provided to sandwich the plurality of bus bars 42 arranged in the horizontal direction. For example, the plurality of members are integrated by sandwiching the plurality of bus bars 42 through laminate molding, for example. The plurality of members form the first flat surface portion 51. In this case, the accommodation portion 55 may be formed in a hollow shape inside the base plate 41 (between the plurality of members). The plurality of members may be a plurality of plate members, a plurality of sheet members, or a combination of a plate member and a sheet member. The sheet member may be, for example, a flexible sheet member. The first flat surface portion 51 formed of the plurality of members has an opening that exposes at least the connection portion 61 of the bus bar 42.

### Eighth Modification Example

A connection between the electronic component 10 and the bus bar 42 is not limited to the connection using the connection component 20. The electronic component 10 may be directly connected to the bus bar 42 by using a fastening member (for example, a bolt or a screw), welding, or the like.

Several embodiments and modification examples have been described above. However, the embodiment and the modification examples are not limited to the examples described above. For example, a plurality of embodiments may be implemented in combination with each other.

### DESCRIPTION OF REFERENCE SYMBOLS

1 Electrical connection unit
10 Electronic component
10X Electronic component
10Y Electronic component
10Z Electronic component
11 Case
11a Insulating rib
12 Component Body
13 Terminal
13A Terminal
13B Terminal
13h Attachment hole
14 Attachment portion
14h Attachment hole
16 Braking portion
17 Movable portion
20 Connection component
21 First portion
21h First attachment hole
22 Second portion
22h Second attachment hole
40 Routing board
40M Routing board
40X Routing board
40Y Routing board
40Z Routing board
41 Base plate (base member)
42 Bus bar
42h Through-hole
42p Plate portion
43 Fastening member
43a Shaft
43b Head
44 Engagement member
51 First flat surface portion (first base portion)
51a First surface
51b Second surface
51h Through-hole
52 First fixing portion
52a Standing plate portion
52b Horizontal plate portion
52h Insertion hole
55 Accommodation portion
61 Connection portion
63 Extending portion
71 Fastening member
80 Metal plate (rigid member)
80e1 First end
80e2 Second end
80e3 Third end
80e4 Fourth end
81 Second flat surface portion (second base portion)
82 Second fixing portion
82h Engagement hole
83 Third fixing portion
83h Engagement hole
91 Insulating sheet
92 Heat transfer member
93 Insulating cover
93h Vent hole
94 Cushion member
95 First cushion element
96 Second cushion element
111 Fastening member
112 Fastening member
L11 Width
L12 Width
MU Main body
S1 Gap
SU Subunit
SUX Subunit
SUY Subunit
SUZ Subunit

1. An electrical connection unit comprising:
a rigid member;
an electronic component including a movable portion;
a bus bar electrically connected to the electronic component;
a base member including a first base portion that has a first surface facing the electronic component and a second surface located on a side opposite to the first surface and facing the rigid member and holds the bus bar, and a first fixing portion fixed to the rigid member; and
a cushion member disposed between the rigid member and the base member or between the rigid member and the bus bar, and disposed between the electronic component and the first fixing portion when viewed from an intersecting direction intersecting the first surface.

2. The electrical connection unit according to claim 1, wherein
the rigid member includes a second base portion that faces the second surface, and a second fixing portion that protrudes from the second base portion in the intersecting direction and to which the first fixing portion is fixed.

3. The electrical connection unit according to claim 1, wherein
a first cushion element disposed between the rigid member and the base member and separated from the bus bar when viewed in the intersecting direction is provided as the cushion member.

4. The electrical connection unit according to claim 1, wherein
a second cushion element disposed between the rigid member and the bus bar and overlapping the bus bar when viewed from the intersecting direction is provided as the cushion member.

5. The electrical connection unit according to claim 1, wherein
a metal plate is provided as the rigid member.
